(19) United States
(12) Patent Application Publication
(10) Pub. No.: US 2025/0053214 A1
(43) Pub. Date: Feb. 13, 2025

(54) INFORMATION PROCESSING APPARATUS AND INPUT CONTROL METHOD

(71) Applicant: Lenovo (Singapore) Pte. Ltd., Singapore (SG)

(72) Inventors: Asahi Tokyo, Kanagawa (JP); Kazuya Shibayama, Kanagawa (JP); Atsunobu Nakamura, Kanagawa (JP); Hidekazu Chujo, Kanagawa (JP)

(73) Assignee: Lenovo (Singapore) Pte. Ltd., Singapore (SG)

(21) Appl. No.: 18/774,199

(22) Filed: Jul. 16, 2024

(30) Foreign Application Priority Data
Aug. 7, 2023 (JP) 2023-128638

(51) Int. Cl. G06F 1/20; G06F 1/16; G06F 3/041

(52) U.S. Cl. CPC G06F 1/206; G06F 1/1616; G06F 1/1677; G06F 3/0412

(57) ABSTRACT

An information processing apparatus, having a first chassis and a second chassis, the first chassis and the second chassis being connected so as to be relatively openable and closable, includes: a touch panel provided in the first chassis; a temperature sensor; a temperature acquisition unit for acquiring a touch panel temperature on the basis of a temperature measured by the temperature sensor; and a mode setting unit that has a plurality of touch modes including a touch disable mode that disables an operation of input to the touch panel and a touch enable mode that enables an operation of input to the touch panel, and sets any one of touch modes on the basis of the touch panel temperature.

### CROSS-REFERENCE TO RELATED APPLICATIONS

This application claims priority to Japanese Patent Application No. 2023-128638 filed on Aug. 7, 2023, the contents of which are hereby incorporated herein by reference in their entirety.

### TECHNICAL FIELD

The present disclosure relates to an information processing apparatus and an input control method.

### BACKGROUND

There are cases where a laptop PC is connected to an external monitor and used while closed.

If a laptop PC having a touch panel display installed therein is used while closed, the heat of a motherboard is transferred to the touch panel display, causing the temperature of the touch panel display to become locally high in some cases.

When the temperature of the touch panel display rises, the impedance of a touch sensor decreases, and a phenomenon called ghost touch may occur, in which it is erroneously determined that a touch input has been made in that particular area. Such a ghost touch is particularly likely to occur when, for example, the distance between a display surface and the touch sensor is relatively short, or when using a structure or a material that provides high thermal conductivity from a heat source to the touch panel display.

### SUMMARY

One or more embodiments of the invention provide an information processing apparatus and an input control method that make it possible to reduce the risk of erroneous determination of a touch input caused by heat.

One or more embodiments include an information processing apparatus having a first chassis and a second chassis, the first chassis and the second chassis being connected so as to be relatively openable and closable, the information processing apparatus including: a touch panel provided in the first chassis; a temperature sensor; a temperature acquisition unit for acquiring a touch panel temperature on the basis of a temperature measured by the temperature sensor; and a mode setting unit that has a plurality of touch modes including a touch disable mode that disables an operation of input to the touch panel and a touch enable mode that enables an operation of input to the touch panel, and sets any one of the touch modes on the basis of the touch panel temperature.

One or more embodiments include an input control method for an information processing apparatus having a first chassis provided with a touch panel, a second chassis, and a temperature sensor, the first chassis and the second chassis being connected so as to be relatively openable and closable, the input control method including: a temperature acquisition step of acquiring a touch panel temperature on the basis of a temperature measured by the temperature sensor; and a mode setting step that has a plurality of touch modes including a touch disable mode that disables an operation of input to the touch panel and a touch enable mode that enables an operation of input to the touch panel, and sets any one of the touch modes on the basis of the touch panel temperature, wherein the temperature acquisition step and the mode setting step are executed by a computer.

According to one or more embodiments, the risk of erroneous determination of touch inputs caused by heat can be reduced.

### BRIEF DESCRIPTION OF THE DRAWINGS

FIG. 1 is a schematic external view of an information processing apparatus according to one or more embodiments of the present disclosure, and is a diagram illustrating an example of a lid open state.

FIG. 2 is a schematic external view of the information processing apparatus according to one or more embodiments of the present disclosure, and is a diagram illustrating an example of a lid closed state.

FIG. 3 is a block diagram illustrating an example of a hardware configuration of the information processing apparatus according to one or more embodiments of the present disclosure.

FIG. 4 is a functional block diagram illustrating exemplary functions of the information processing apparatus according to one or more embodiments of the present disclosure.

FIG. 5 is a flowchart illustrating an example of the processing procedure of touch disable determination processing in input control processing related to one or more embodiments of the present disclosure.

FIG. 6 is a flowchart illustrating an example of the processing procedure of touch enable determination processing in input control processing related to one or more embodiments of the present disclosure.

### DETAILED DESCRIPTION

The following will describe an information processing apparatus and an input control method according to embodiments of the present disclosure with reference to the accompanying drawings. Although a laptop PC will be illustrated and described below as an example of an information processing apparatus 1, the information processing apparatus 1 according to one or more embodiments is not limited thereto. For example, as will be described later, any information processing apparatus may be used as long as the information processing apparatus includes a first chassis and a second chassis and these chassis are configured to be relatively openable and closable. Another example is a 2-in-1 type PC.

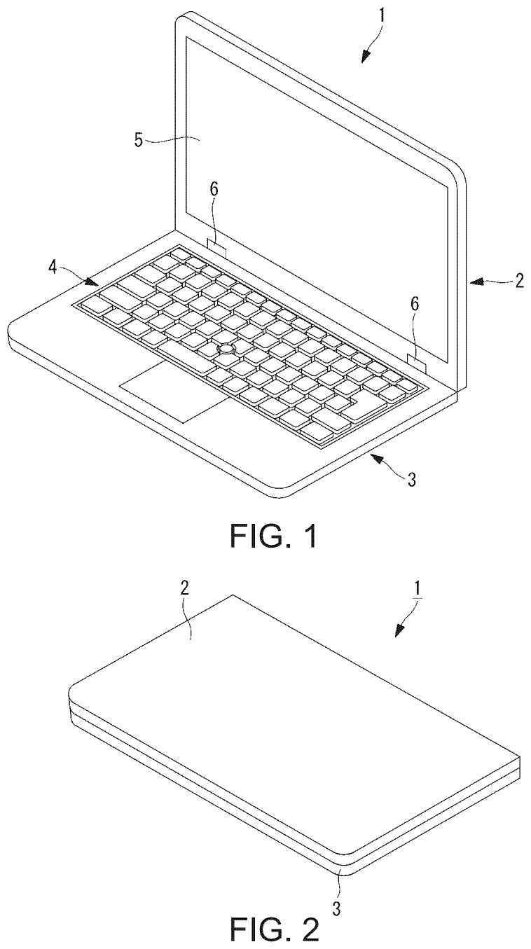

FIG. 1 and FIG. 2 are schematic external views of the information processing apparatus 1 according to one or more embodiments of the present disclosure. FIG. 1 illustrates a state in which a first chassis 2 is opened with respect to a second chassis 3, i.e., a lid open state, and FIG. 2 illustrates a state in which the first chassis 2 is closed with respect to the second chassis 3, i.e., a lid closed state.

As illustrated in FIG. 1, the information processing apparatus 1 has the first chassis 2 and the second chassis 3. The first chassis 2 and the second chassis 3 are connected so as to be relatively openable and closable through connection members 6. Examples of the connection members 6 include hinges.

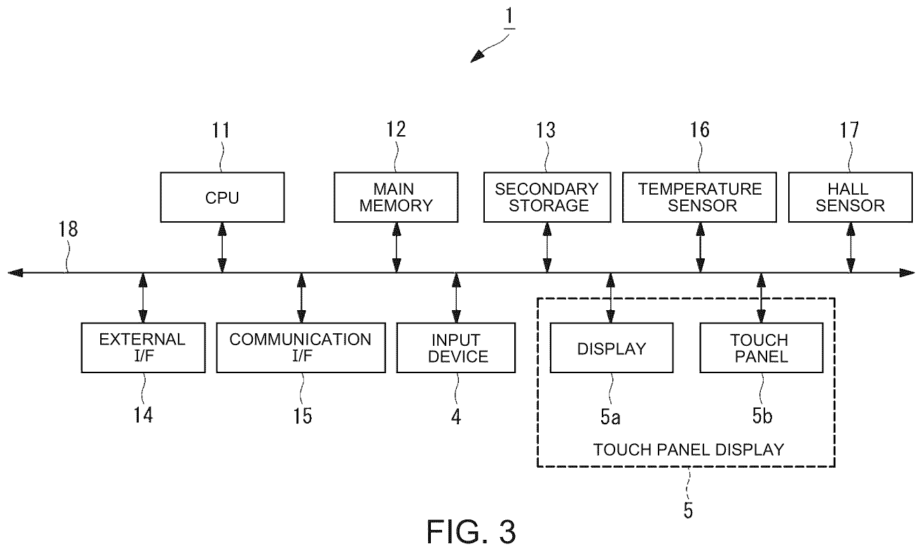

The first chassis 2 has a substantially rectangular shape, and includes a touch panel display 5 provided in a surface opposed to the second chassis 3. In the touch panel display 5, for example, a touch panel 5b (refer to FIG. 3) that allows input by a pen or a finger is superimposed on a display 5a (refer to FIG. 3). For the structure of the touch panel display 5, a publicly-known technology may be adopted as appropriate, and a detailed description thereof will be omitted here.

The second chassis 3 has a substantially rectangular shape, and a first surface of the second chassis 3 is provided with an input device 4. The input device 4 is a user interface for a user to perform input operations. Examples of the input device 4 include a keyboard, a touch pad, a track point, and the like. The input device 4 may be a software keyboard or the like. In other words, the first surface of the second chassis 3 has a touch panel, and a screen of a keyboard or the like may be displayed on the touch panel such that the touch panel functions as the input device 4.

A description will now be given of the hardware configuration of the information processing apparatus 1 according to one or more embodiments with reference to FIG. 3. FIG. 3 is a block diagram illustrating an example of the hardware configuration of the information processing apparatus 1 according to one or more embodiments. As illustrated in FIG. 3, the information processing apparatus 1 includes, for example, a CPU (Central Processing Unit: processor) 11, a main memory 12, a secondary storage (memory) 13, an external interface 14, a communication interface 15, a temperature sensor 16, and a Hall sensor 17, in addition to the input device 4 and the touch panel display 5 described above. These parts are connected to each other directly or indirectly via a bus 18, and interact with each other to execute various types of processing.

A CPU 11 controls the entire information processing apparatus 1 by an OS (Operating System) stored in the secondary storage 13 connected via, for example, the bus 18, and executes various types of processing by running various programs stored in the secondary storage 13. One or a plurality of CPUs 11 may be provided and may cooperate with each other to perform processing.

The main memory 12 is composed of a writable memory such as, for example, a cache memory and a RAM (Random Access Memory), and is used as a work area for reading an execution program of the CPU 11, writing processing data by the execution program, and the like.

The secondary storage 13 is a non-transitory computer readable storage medium. The secondary storage 13 is, for example, a magnetic disk, a magneto-optical disk, a CD-ROM, a DVD-ROM, a semiconductor memory, or the like. Examples of the secondary storage 13 include a ROM (Read Only Memory), an HDD (Hard Disk Drive), an SSD (Solid State Drive) flash memory, and the like. The secondary storage 13 stores, for example, an OS and a BIOS (Basic Input/Output System) for controlling the entire information processing apparatus, such as Windows (registered trademark), iOS (registered trademark), and Android (registered trademark), and various device drivers and various types of application software for the hardware operation of peripherals, and various data, files, and the like. Further, the secondary storage 13 stores programs for performing various types of processing, and various data required for performing various types of processing. A plurality of the secondary storages 13 may be provided, and programs and data described above may be divided and stored in each secondary storage 13.

The external interface 14 is an interface for connection with an external device. Examples of the external device include an external monitor, a USB memory, an external HDD, an external camera, and the like. Although only one external interface is illustrated in the example illustrated in FIG. 3, a plurality of external interfaces may be provided.

The communication interface 15 functions as an interface connected to a network to perform communication with other devices thereby to transmit and receive information. For example, the communication interface 15 communicates with other devices by wire or wirelessly. Examples of wireless communication include communication through lines such as Bluetooth (registered trademark), Wi-Fi, mobile communication systems (3G, 4G, 5G, 6G, LTE, and the like), and wireless LAN. An example of wired communication is communication through a line such as a wired LAN (Local Area Network).

The temperature sensor 16 is provided inside, for example, the second chassis 3. There may be one or a plurality of the temperature sensors 16. The temperature sensor 16 is placed, for example, at a location where the temperature tends to rise inside the second chassis 3. An example of the location may be the vicinity of a motherboard housed inside the second chassis 3, on the motherboard, the vicinity of a power element, or the like. Temperatures measured by the temperature sensor 16 are output to the CPU 11.

The present embodiments illustrates and describes the case where the temperature sensor 16 is provided inside the second chassis 3; however, the installation position and the number thereof to be installed are not limited thereto, and are not particularly limited. For example, the temperature sensor 16 may be provided inside the first chassis 2. Further, the temperature sensor 16 may be provided on the surface of the first chassis 2 or the surface of the second chassis 3 other than the inside thereof.

The Hall sensor 17 has, for example, a Hall element in one of the first chassis 2 and the second chassis 3, and a magnet in the other chassis. As an example, the Hall element is placed inside the first chassis 2. The position where the Hall element is placed corresponds to the position where the magnet (not illustrated) is placed inside the second chassis 3. More specifically, the Hall element and the magnet are placed such that the Hall element and the magnet are opposed to each other in a closed state in which the information processing apparatus 1 is closed.

In the Hall sensor 17, the magnetic field generated from the magnet placed inside the second chassis 3 is detected by the Hall element, and the detection result of the magnetic field is output to the CPU 11. Detecting the magnetic field by the Hall element enables the CPU 11 to determine whether the information processing apparatus 1 is open or closed.

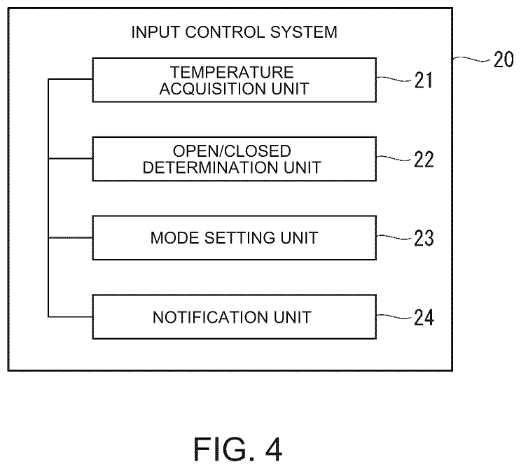

FIG. 4 is a functional block diagram illustrating exemplary functions of the information processing apparatus 1. As illustrated in FIG. 4, the information processing apparatus 1 includes an input control system 20. The input control system 20 includes, for example, a temperature acquisition unit 21, an open/closed determination unit 22, a mode setting unit 23, and a notification unit 24.

A series of processes for implementing various functions of the input control system 20 are, for example, stored in the secondary storage 13 or the like in the form of a program, and the CPU (processor) 11 reads this program into the main memory 12 and executes information processing and arithmetic processing thereby to implement various functions. The program may be provided in the form of being pre-installed in the secondary storage 13, being stored in a non-transient computer-readable storage medium, being delivered via a wired or wireless communication unit, or the like. Examples of the non-transient computer-readable storage medium include a magnetic disk, a magneto-optical disk, a CD-ROM, a DVD-ROM, and a semiconductor memory.

The temperature acquisition unit 21 acquires a touch panel temperature on the basis of a temperature measured by the temperature sensor 16. For example, if one temperature sensor 16 is provided, the temperature acquisition unit 21 may acquire a temperature measurement value of the temperature sensor 16 by regarding the temperature measurement value as the touch panel temperature. Further, the temperature acquisition unit 21 may include an arithmetic expression in advance to estimate the touch panel temperature from a temperature measurement value, and the arithmetic expression may use a temperature measurement value so as to acquire the touch panel temperature by calculation. Further, if a plurality of the temperature sensors 16 are provided, the touch panel temperature may be calculated according to a predetermined algorithm from the measurement values of the plurality of the temperature sensors 16. For example, among the measurement values of the plurality of temperature sensors 16, a maximum value may be used as the touch panel temperature, or statistical processing may be performed on a plurality of temperature measurement values thereby to acquire the touch panel temperature.

Further, which temperature should be adopted as the touch panel temperature may be determined as appropriate, and a touch disable threshold value and a touch enable threshold value, which will be described later, may be set to appropriate values according to a defined “touch panel temperature.”

The open/closed determination unit 22 determine whether the first chassis 2 and the second chassis 3 are open or closed on the basis of an output of the Hall sensor 17. More specifically, the open/closed determination unit 22 determines whether the state is a lid open state, in which the first chassis 2 and the second chassis 3 are open, or a lid closed state, in which the first chassis 2 and the second chassis 3 are closed, on the basis of an output from the Hall sensor 17.

The lid closed state refers to a case where, for example, the angle formed by the first chassis 2 and the second chassis 3 is substantially zero degrees, and a state that is not the lid closed state is referred to as the lid open state.

The mode setting unit 23 has a plurality of touch modes, including, for example, a touch disable mode, which disables an operation of input to the touch panel 5b, and a touch enable mode, which enables an operation of input to the touch panel 5b.

Here, the touch disable mode shall include, for example, disabling input to the touch panel 5b, as well as, for example, forcibly reducing the sensitivity of the touch panel 5b to a predetermined value or lower, so that touch input cannot be sensed.

The mode setting unit 23 sets one of the touch modes on the basis of the touch panel temperature acquired by the temperature acquisition unit 21 and the open/closed state of the first chassis 2 and the second chassis 3 determined by the open/closed determination unit 22.

More specifically, the mode setting unit 23 sets the touch disable mode if the lid closed state and the state in which the touch panel temperature is a predetermined touch disable threshold value or more are maintained for a predetermined period of time.

Further, the mode setting unit 23 sets the touch enable mode if a first condition, in which the state is the lid open state, or a second condition in which the touch panel temperature is below a predetermined touch enable threshold value, is satisfied after a predetermined period of time elapses since the first condition or the second condition is satisfied.

Here, the touch disable threshold value is, for example, a temperature threshold value determined on the basis of a temperature at which a ghost touch occurs. Further, the touch enable threshold value is, for example, a temperature threshold value determined on the basis of a temperature at which no ghost touch occurs. The touch disable threshold value and the touch enable threshold value may be the same value or different values. If the touch disable threshold value and the touch enable threshold value are different values, then the touch disable threshold value is set to be larger than the touch enable threshold value.

The notification unit 24 notifies a touch mode change when touch mode setting is changed by the mode setting unit 23. For example, the notification unit 24 notifies the user of the touch mode change by displaying, on the display 5a, a message to the effect that the touch mode has been changed. The notification method is not limited to this, and the user may be notified, for example, by voice. Further, the touch mode may be notified to the user by using a light emitting element such as an LED, which is lit up in a color corresponding to each mode.

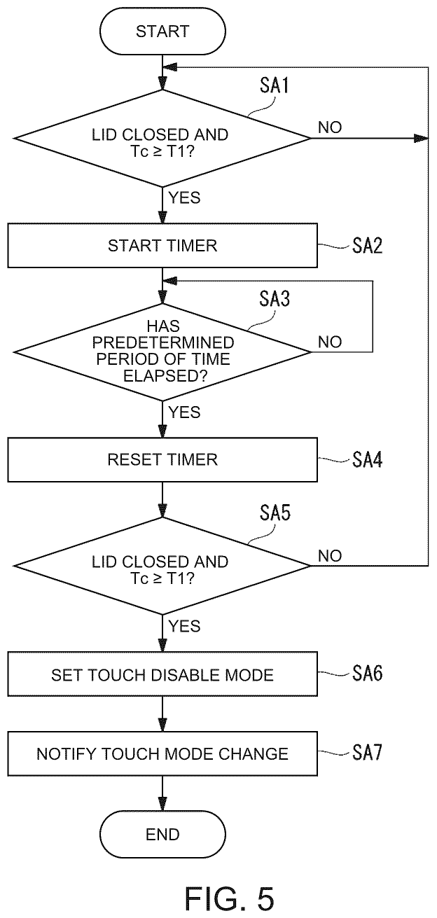

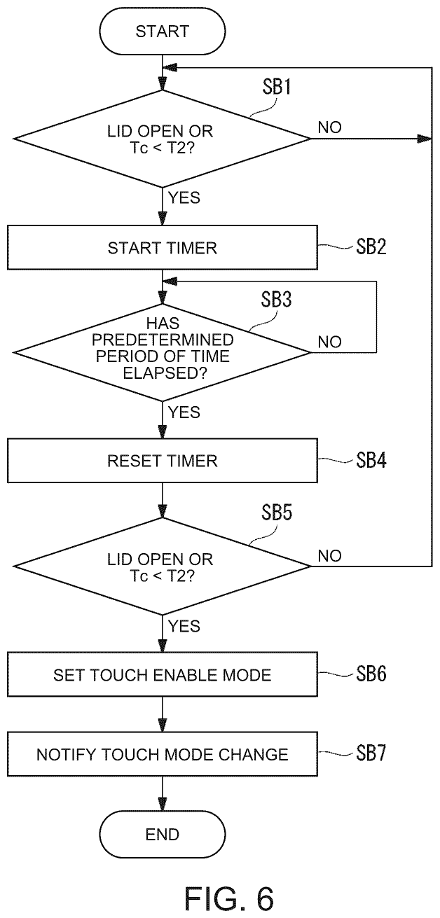

A description will now be given of an input control processing (input control method) executed by the input control system 20 of the information processing apparatus 1 with reference to FIG. 5 and FIG. 6. FIG. 5 and FIG. 6 are flowcharts illustrating examples of the processing procedure of the input control processing according to one or more embodiments of the present disclosure. The series of processing described below is performed by, for example, the CPU 11 reading an input control program stored in the secondary storage 13 out into the main memory 12 and executing information processing and arithmetic processing.

The input control processing has, for example, touch disable determination processing (refer to FIG. 5) and touch enable determination processing (refer to FIG. 6). Further, the touch disable determination processing is repeatedly executed during a period of time in which, for example, the touch enable mode is set, and the touch enable determination processing is repeatedly executed during a period of time in which the touch disable mode is set.

First, referring to FIG. 5, the touch disable determination processing will be described.

The input control system 20 determines whether the state is the lid closed state and a touch panel temperature Tc is a predetermined touch disable threshold value T1 or higher (SA1). If the determination result indicates that this condition is not satisfied (NO in SA1), then the processing is repeated. On the other hand, if the state is the lid closed state and the touch panel temperature Tc is the touch disable threshold value T1 or higher (YES in SA1), then a timer is started (SA2), and then the system waits until the timer reaches a predetermined time (NO in SA3). Then, when the timer reaches the predetermined time (YES in SA3), the timer is reset (SA4), and then it is determined again whether the state is the lid closed state and the touch panel temperature Tc is the touch disable threshold value T1 or higher (SA5). If the determination result indicates that this condition is not satisfied (NO in SA5), then the system returns to step SA1 and repeats the above-described processing. On the other hand, if the state is the lid closed state and the touch panel temperature Tc is the predetermined touch disable threshold value T1 or higher (YES in SA5), then the touch disable mode is set (SA6). Subsequently, the touch mode change is notified (SA7), e.g., that the touch disable mode has been set, and the processing is terminated.

Referring now to FIG. 6, the touch enable determination processing will be described.

The input control system 20 determines whether the state is the lid open state (condition 1) or the touch panel temperature Tc is below a predetermined touch enable threshold value T2 (condition 2) (SB1). If the determination result indicates that neither of the conditions is satisfied (NO in SB1), then the processing is repeated. On the other hand, if the state is the lid open state or the touch panel temperature Tc is below the touch enable threshold value T2 (YES in SB1), then the timer is started (SB2), and the system waits until the timer reaches a predetermined time (NO in SB3). Then, when the timer reaches the predetermined time (YES in SB3), the timer is reset (SB4), and then the system determines whether the state is the lid open state or the touch panel temperature Tc is below the touch enable threshold value T2 (SB5). If the determination result satisfies neither of the conditions (NO in SB5), then the system returns to step SB1 and repeats the processing. On the other hand, if the state is the lid open state or the touch panel temperature Tc is below the touch enable threshold value T2 (YES in SB5), then the touch enable mode is set (SB6). Subsequently, the touch mode change is notified (SB7), e.g., that the touch enable mode has been set, and the processing is terminated.

As described above, one or more embodiments have a plurality of touch modes, including the touch disable mode, which disables the operation of input to the touch panel 5b, and the touch enable mode, which enables the operation of input to the touch panel 5b, and sets one of the touch modes on the basis of the touch panel temperature and the open/closed state of the first chassis 2 and the second chassis 3.

Thus, when, for example, the information processing apparatus 1 is in use in the closed state (refer to FIG. 2) and the touch panel temperature rises, the touch disable mode, which disables the operation of input to the touch panel 5b, is set. This makes it possible to reduce the risk of erroneous determination of touch inputs caused by heat.

In addition, when the information processing apparatus 1 is no longer in the closed state (refer to, for example, FIG. 1) or the touch panel temperature falls below the enable threshold value, the touch enable mode, which enables the operation of input to the touch panel 5b, is set. This enables the user to perform touch input to the touch panel 5b.

The above has described embodiments of the present disclosure; however, the technological scope of the present disclosure is not limited to the scope of the embodiments described above. A variety of changes or improvements can be added to the above-described embodiments without departing from the gist of the disclosure, and embodiments with such changes or improvements added thereto will be included in the technological scope of the present disclosure. Further, the above-described embodiments may be combined as appropriate.

Further, the flow of processing described in the embodiments is an example, and unnecessary steps may be deleted, new steps may be added, or the order of processing may be changed within the range not departing from the gist of the present disclosure.

### Modified Example 1

For example, in the embodiments described above, the Hall sensor 17 is used to determine whether the first chassis 2 and the second chassis 3 are open or closed; however, the present disclosure is not limited thereto. For example, in place of the Hall sensor, a physical switch may be used to determine the open/closed state. Further, the angle formed by the first surface of the first chassis 2 and the first surface of the second chassis 3 may be defined as a posture angle θ, and an acceleration sensor may be used to determine the open/closed state on the basis of the posture angle θ.

### Modified Example 2

Further, in the embodiments described above, the touch mode is set on the basis of a touch sensor temperature and the open/closed state of the first chassis 2 and the second chassis 3; however, the present disclosure is not limited thereto. For example, the touch mode may be set on the basis of the touch sensor temperature regardless of the open/closed state of the first chassis 2 and the second chassis 3, i.e., regardless of whether the state is the lid closed state or the lid open state. In this case, for example, the touch disable mode may be set when the touch sensor temperature is the disable threshold value or higher, and the touch enable mode may be set when the touch sensor temperature is below the enable threshold value.

### Modified Example 3

Further, in the embodiments described above, a timer is used in the touch disable determination processing; however, the timer may be omitted. More specifically, steps SA2 to SA5 may be omitted, and the touch disable mode may be set if the result of determination in step SA1 is affirmative (YES in SA1). Similarly, in the touch enable determination processing, the timer may be omitted, i.e., steps SB2 to SB5 may be omitted, and the touch enable mode may be set if the result of determination in step SB1 is affirmative (YES in SB1).

### Modified Example 4

Further, in the above-described embodiments, the input operation is enabled or disabled in the entire touch panel 5b; however, the present disclosure is not limited thereto. For example, the touch panel 5b may be divided into a plurality of areas, and a temperature sensor for acquiring a touch panel temperature may be provided for each divided area and the touch mode may be set for each divided area. This makes it possible to disable touch input only in an area where the temperature has locally increased. As a result, the touch panel 5b can be effectively used in the lid open state.

Further, the above-described embodiments and modified examples 1 to 4 can be applied in combination as appropriate.

### DESCRIPTION OF SYMBOLS

1 information processing apparatus
2 first chassis
3 second chassis
4 input device
5 touch panel display
5a display
5b touch panel
6 connection member
11 CPU
12 main memory
13 secondary storage
14 external interface
15 communication interface
16 temperature sensor
17 Hall sensor
18 bus
20 input control system
21 temperature acquisition unit
22 open/closed determination unit
23 mode setting unit
24 notification unit

What is claimed is:

1. An information processing apparatus having a first chassis and a second chassis, the first chassis and the second chassis being connected so as to be relatively openable and closable, the information processing apparatus comprising:
a touch panel provided in the first chassis;
a temperature sensor;
a temperature acquisition unit for acquiring a touch panel temperature on the basis of a temperature measured by the temperature sensor; and
a mode setting unit that has a plurality of touch modes including a touch disable mode that disables an operation of input to the touch panel and a touch enable mode that enables an operation of input to the touch panel, and sets any one of touch modes on the basis of the touch panel temperature.

2. The information processing apparatus according to claim 1, including:
an open/closed determination unit for determining an open/closed state of the first chassis and the second chassis,
wherein the mode setting unit sets the touch mode on the basis of the touch panel temperature and the open/closed state of the first chassis and the second chassis.

3. The information processing apparatus according to claim 2, wherein the mode setting unit sets the touch disable mode in the case where the first chassis and the second chassis are in a closed state, and the touch panel temperature is a predetermined touch disable threshold value or higher.

4. The information processing apparatus according to claim 2, wherein the mode setting unit sets the touch disable mode in the case where a state in which the first chassis and the second chassis are closed, and a state in which the touch panel temperature is a predetermined touch disable threshold value or higher are maintained for a predetermined period of time.

5. The information processing apparatus according to claim 2, wherein the mode setting unit sets the touch enable mode in the case where the first chassis and the second chassis are in an open state, or the touch panel temperature is below a predetermined touch enable threshold value.

6. The information processing apparatus according to claim 2, wherein the mode setting unit sets the touch enable mode in the case where a first condition in which the first chassis and the second chassis are in an open state, or a second condition in which the touch panel temperature is below a predetermined touch enable threshold value, is satisfied after a predetermined period of time elapses since the first condition or the second condition is satisfied.

7. The information processing apparatus according to claim 1, including a notification unit for notifying a touch mode change in the case where a touch mode setting is changed by the mode setting unit.

8. An input control method for an information processing apparatus having a first chassis provided with a touch panel, a second chassis, and a temperature sensor, the first chassis and the second chassis being connected so as to be relatively openable and closable, the input control method comprising:
a temperature acquisition step of acquiring a touch panel temperature on the basis of a temperature measured by the temperature sensor; and
a mode setting step that has a plurality of touch modes including a touch disable mode that disables an operation of input to the touch panel and a touch enable mode that enables an operation of input to the touch panel, and sets any one of touch modes on the basis of the touch panel temperature,
wherein the temperature acquisition step and the mode setting step are executed by a computer.
